(19) United States
(12) Patent Application Publication
(10) Pub. No.: US 2011/0140520 A1
(43) Pub. Date: Jun. 16, 2011

(54) ENERGY STORAGE SYSTEM AND METHOD OF CONTROLLING THE SAME

(76) Inventor: Sung-Im Lee, Yongin-si (KR)

(21) Appl. No.: 12/854,858

(22) Filed: Aug. 11, 2010

(30) Foreign Application Priority Data
Dec. 16, 2009 (KR) 10-2009-0125692

(51) Int. Cl. H02J 4/00

(52) U.S. Cl. 307/25

(57) ABSTRACT

A grid-connected energy storage system and a method of controlling the energy storage system. In the energy storage system, a normal operation of the energy storage system and the UPS function due to electrical failure may be stably performed even if electrical failure occurs. The energy storage system includes: a maximum power point tracking (MPPT) converter outputting converted power to a first node; a battery storing power; a bi-directional inverter converting power and outputting the converted power to the load, the grid or the first node; a bi-directional converter converting and storing power in the battery and outputting the power stored in the battery to the first node; and an integrated controller controlling the MPPT converter, the bi-directional inverter and the bi-directional converter.

### CROSS-REFERENCE TO RELATED APPLICATION

This application claims the benefit of Korean Patent Application No. 10-2009-0125692, filed Dec. 16, 2009, in the Korean Intellectual Property Office, the disclosure of which is incorporated herein by reference.

### BACKGROUND

1. Field

Aspects of the present invention relate to an energy storage system and a method of controlling the same, and more particularly, to a grid-connected energy storage system including a renewable power generation system and a method of controlling the energy storage system.

2. Description of the Related Art

As problems such as environmental destruction and resource depletion arise, interest in a system for storing power and efficiently using the stored power is increasing. Also, interest in renewable energy, such as photovoltaic power generation, is increasing. In particular, renewable energy uses resources that may be replenished or renewable natural resources such as sun light, wind, and tides and power generation using the renewable energy does not pollute the environment. Thus, research is being actively conducted on a method of utilizing renewable energy.

Recently, a system of improving energy efficiency by using information technology connected to an existing power system, wherein information is exchanged between a power supplier and a consumer, which is called a smart grid system, has been introduced. In addition, a photovoltaic system in connection with photovoltaic power generation and an uninterruptible power supply (UPS) device has been introduced.

### SUMMARY

Aspects of the present invention include an energy storage system which may stabilize when connected to a battery and a renewable power generation system when an uninterruptible power supply (UPS) function is performed in an abnormal state, for example, a power failure, and a method of controlling the energy storage system.

According to an aspect of the present invention, an energy storage system includes: a maximum power point tracking (MPPT) converter converting power generated by a renewable power generation system and outputting the converted power to a first node; a bi-directional inverter, connected between the first node and a second node, the second node being connected to a grid and a load, converting a first direct current (DC) power input through the first node to an alternating current (AC) power and outputting the AC power to the second node, and converting an AC power from the grid to the first DC power and outputting the first DC power to the first node; a battery for storing a second DC power; a bi-directional converter, connected between the battery and the first node, converting the second DC power output from the battery to the first DC power and outputting the first DC power to the bi-directional inverter through the first node, and converting the first DC power output from the bi-directional inverter through the first node to the second DC power; and an integrated controller sensing an electrical failure signal of the grid and controlling the second DC power stored in the battery to be transferred to the load when the electrical failure signal is received.

According to another aspect of the present invention, the integrated controller may turn the bi-directional converter on and perform constant voltage control of the first node when the electrical failure signal is received.

According to another aspect of the present invention, when the electrical failure signal is received, the integrated controller may turn the bi-directional inverter and the MPPT converter off, turn the bi-directional converter on, and turn the bi-directional inverter on.

According to another aspect of the present invention, the system may further include: a first switch connected between the bi-directional inverter and the load; and a second switch connected between the second node and the grid.

According to another aspect of the present invention, when the electrical failure signal is received, the integrated controller may turn the second switch off.

According to another aspect of the present invention, the integrated controller may turn the bi-directional inverter on and then turn the MPPT converter on.

According to another aspect of the present invention, the integrated controller may turn the MPPT converter on and then turn the bi-directional converter off.

According to another aspect of the present invention, the system may further include a battery management system (BMS) for managing charging and/or discharging the second DC power stored in the battery according to control of the integrated controller.

According to another aspect of the present invention, the system may further include a DC link unit maintaining a DC voltage level of the first node to a DC link level.

According to another aspect of the present invention, the renewable power generation system may be a Photovoltaic (PV) system.

According to an aspect of the present invention, there is provided a method of controlling an energy storage system supplying power to a load when an electrical failure occurs in a grid, wherein the energy storage system is connected to a renewable power generation system, the load, and the grid and the energy storage system includes: a maximum power point tracking (MPPT) converter outputting converted power to a first node; a battery storing power; a bi-directional inverter converting power and outputting the converted power to the load, the grid or the first node; a bi-directional converter converting and storing power in the battery and outputting the power stored in the battery to the first node; and an integrated controller, the method including: receiving an electrical failure signal of the grid; turning the MPPT converter and the bi-directional inverter off; turning the bi-directional converter on; performing constant voltage control of the first node to stabilize the first node; turning the bi-directional inverter on; and supplying the power stored in the battery to the load.

According to another aspect of the present invention, the bi-directional converter may convert a first direct current (DC) voltage of the power stored in the battery into a second DC voltage and perform the constant voltage control of the first node.

According to another aspect of the present invention, when the voltage of the first node is stabilized, the method may further include turning the MPPT converter on and supplying power generated by the renewable power generation system to the load.

According to another aspect of the present invention, the method may further include turning the bi-directional converter off and stopping the supplying of the power stored in the battery.

According to another aspect of the present invention, when the electrical failure signal is received, the method may further include turning off a switch connected to the grid.

According to another aspect of the present invention, the renewable power generation system may be a Photovoltaic (PV) system.

According to another aspect of the present invention, the method may further include stabilizing a voltage level of the first node to be at a voltage level of a direct current (DC) link.

According to another aspect of the present invention, the method may further include controlling discharging of the battery so that the power stored in the battery is input to the bi-directional converter.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a grid-connected energy storage system, according to an embodiment of the present invention;

FIG. 2 is a diagram illustrating flows of power and control signals in the grid-connected energy storage system of FIG. 1, according to another embodiment of the present invention;

FIG. 3 is a block diagram of an integrated controller illustrated in FIG. 1, according to an embodiment of the present invention;

FIG. 4 is a flowchart illustrating a method of controlling an energy storage system, according to an embodiment of the present invention; and

FIG. 5 is a flowchart illustrating a method of controlling an energy storage system, according to another embodiment of the present invention.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Also, terms and expressions used in this specification and claims are not limited to a general and lexical meaning; rather, these terms and expressions may be interpreted as a meaning and concept that meet a technical idea of the present invention so as to appropriately describe aspects of the present invention.

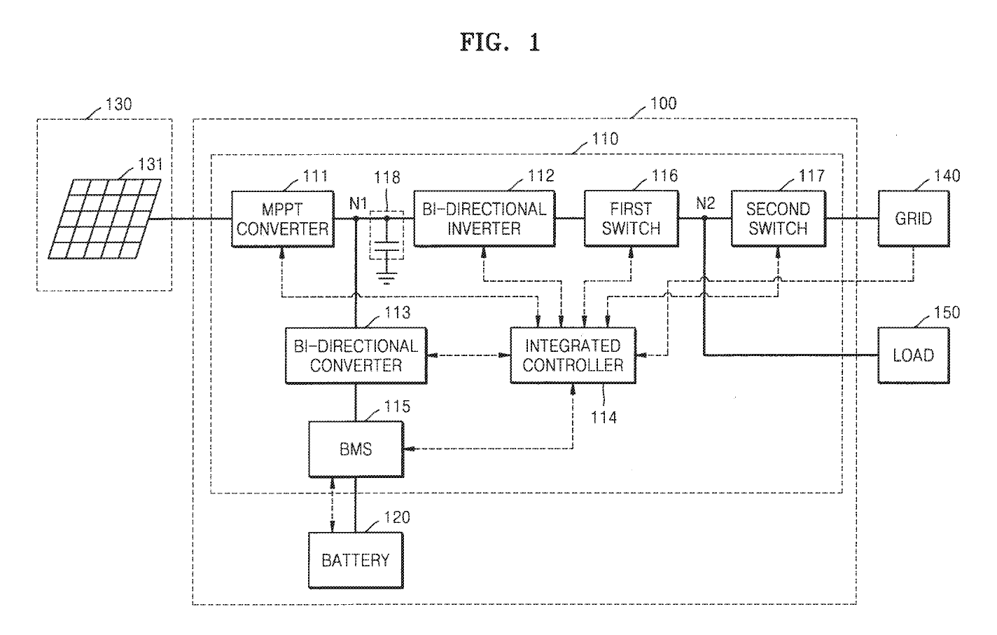

FIG. 1 is a block diagram of a grid-connected energy storage system 100 according to an embodiment of the present invention. Referring to FIG. 1, an energy management system 110 includes a maximum power point tracking (MPPT) converter 111, a bi-directional inverter 112, a bi-directional converter 113, an integrated controller 114, a battery management system (BMS) 115, a first switch 116, a second switch 117, and a direct current (DC) link unit 118. The energy management system 110 is connected to a battery 120, a renewable power generation system 130 including solar cells 131, a grid 140; and a load 150. In the present embodiment, the energy storage system 100, which is grid connected, is configured to include the energy management system 110 and the battery 120. However, aspects of the present invention are not limited thereto, and the grid-connected energy storage system 100 may include an energy management system formed integrally with a battery or other power source.

The renewable power generation system 130 generates power and outputs the generated power to the energy management system 110. The renewable power generation system 130 includes the solar cells 131. However, aspects of the present invention are not limited thereto, and the renewable power generation system 130 may be a wind power generation system or a tidal power generation system. In addition, the renewable power generation system 130 may be a power generation system generating electric energy by using renewable energy such as photovoltaic energy, geothermal energy or other suitable renewable energy systems. In particular, solar cells generating electric energy by using photovoltaic energy are easily installed in a house or a plant, and thus, are suitable for the grid-connected energy storage system 100, which is disposed in each house.

The grid 140 includes a power plant, a substation, power transmission cables or other similar elements used in a grid distributing electricity. When the grid 140 is in a normal status, the grid 140 supplies the power to the battery 120 or to the load 150 according to a turning on or off of the first and second switches 116 and 117. Also, the grid 140 receives the power supplied from the battery 120 or the power generated from the renewable power generation system 130. When the grid 140 is in an abnormal status caused by, for example, electrical failure or electrical work, the power supply from the grid 140 to the battery 120 or to the load 150 is stopped. Additionally, in the abnormal status, the power supply from the battery 120 or the renewable power generation system 130 to the grid 140 is also stopped.

The load 150 consumes the power generated by the renewable power generation system 130, the power stored in the battery 120, and the power supplied from the grid 140. The load 150 may be, for example, a house or a plant or other similar power consuming entities.

The MPPT converter 111 converts a DC voltage output from the solar cells 131 into a DC voltage of a first node N1. Since an output of the solar cells 131 varies depending on weather conditions, such as an amount of solar radiation, cloud conditions and temperature, and a load condition, the MPPT converter 111 controls the solar cells 131 to generate a maximum amount of power. That is, the MPPT converter 111 operates as a boost DC-DC converter boosting the DC voltage output from the solar cells 131 and outputs the boosted DC voltage. Additionally, the MPPT converter 111 operates as an MPPT controller. For example, the MPPT converter 111 outputs a DC voltage in the range of about 300 V to about 600 V. However, aspects of the present invention are not limited thereto, and the MPPT converter 111 may output other suitable DC voltages.

In addition, the MPPT converter 111 performs MPPT control tracking the maximum output voltage from the solar cells 131 according to solar radiation and temperature. The MPPT control is executed by a perturbation and observation (P&O) control method, an incremental conductance (IncCond) control method, or a power versus voltage control method. The P&O control method increases or decreases a reference voltage by measuring a current and a voltage of the solar cells 131. The IncCond control method controls the output DC voltage by comparing an output conductance of the solar cells with an incremental conductance of the solar cells 131. The power versus voltage control method controls the output DC voltage by using a slope of a power versus voltage characteristic graph. However, aspects of the present invention are not limited thereto and other MPPT control methods may also be used.

The DC link unit 118 is connected between the first node N1 and the bi-directional inverter 112 in parallel. The DC link unit 118 supplies the DC voltage, output from the MPPT converter 111 to the bi-directional inverter 112 or the bi-directional converter 113 while maintaining the DC voltage level at a DC link level, for example, 380 V DC. However, aspects of the present invention are not limited thereto, and the DC link level may be other suitable voltages. The DC link unit 118 is an aluminum electrolytic capacitor, a polymer capacitor, or a multi-layer ceramic capacitor (MLC). However, aspects of the present invention are not limited thereto, and the DC link unit 118 may be other suitable capacitors or energy storage devices.

The voltage level at the first node N1 is unstable due to variation in the DC voltage output from the solar cells 131, the instantaneous voltage sag of the grid 140, or the peak load occurring at the load 150. Thus, the DC link unit 118 provides the bi-directional converter 113 and the bi-directional inverter 112 with a stabilized DC link voltage in order to have normal operation of the bi-bi-directional converter 113 and the bi-directional inverter 112. In the present embodiment illustrated in FIG. 1, the DC link unit 118 is separately formed. However, aspects of the present invention are not limited thereto, and the DC link unit 118 may be included in the bi-directional converter 113, the bi-directional inverter 112, or the MPPT converter 111.

The bi-directional inverter 112 is connected between the first node N1 and the grid 140. The bi-directional inverter 112 converts the DC voltage output from the MPPT converter 111 and the DC voltage output from bi-directional converter 113 into an AC voltage output to the grid 140 or the load 150. Additionally, the bi-directional inverter 112 converts the AC voltage supplied from the grid 140 to a DC voltage in order to transfer the DC voltage to the first node N1. In other words, the bi-directional inverter 112 operates both as an inverter for converting a DC voltage to an AC voltage and as a rectifier for converting an AC voltage to a DC voltage.

The bi-directional inverter 112 rectifies the AC voltage input from the grid 140 into the DC voltage which is to be stored in the battery 120. The bi-directional converter 112 also converts the DC voltage output from the renewable power generation system 130 or the battery 120 into AC voltage output to the grid 140. The AC voltage output to the grid 140 is output in a manner so as to approximately match a power quality standard of the grid 140. For example, the AC voltage output to the grid 140 has a power factor of 0.9 or greater and a total harmonic distortion (THD) of 5% or less. However, aspects of the present invention are not limited thereto, and the AC voltage output to the grid may be output according to other suitable power quality standards. In this regard, the bi-directional inverter 112 adjusts the AC voltage level and synchronizes a phase of the AC voltage with a phase of the grid 140 in order to prevent reactive power from being generated.

In addition, the bi-directional inverter 112 includes a filter (not shown) to remove a harmonic from the AC voltage output to the grid 140. The filter restricts a voltage changing range, improves a power factor, removes DC components, and protects from transient phenomena of the AC voltage output to the grid 140. Thus, the bi-directional inverter 112 of the present embodiment is an inverter converting the DC power of the renewable power generation system 130 or the battery 120 to AC power to be supplied to the grid 140 or the load 150. Additionally, the bi-directional inverter 112 is a rectifier converting the AC power supplied from the grid 140 into DC power to be supplied to the battery 120.

The bi-directional converter 113 is connected between the first node N1 and the battery 120, and converts the DC voltage at the first node N1 into DC voltage to be stored in the battery 120. In addition, the bi-directional converter 113 converts the DC voltage stored in the battery 120 into the DC voltage level to be transferred to the first node N1. As such, when the bi-directional converter 113 is in a battery charging mode and the DC or AC power is stored in the battery 120, the bi-directional converter 113 functions as a converter which decompresses the DC voltage level at the first node N1 or the DC link voltage level maintained by the DC link DC unit 118 down to a battery storage voltage. For example, when the renewable power generation system 130 supplies a DC power, the bi-directional converter 113 decompresses the DC voltage level at the first node N1 or the DC link voltage lever of 380V down to the battery storage voltage of 100V. However, aspects of the present invention are not limited thereto, and other suitable voltages may be used.

In addition, when the power stored in the battery 120 is supplied to the grid 140 or to the load 150, that is, in a battery discharging mode, the bi-directional converter 113 functions as a converter which boosts the battery storage voltage to the DC voltage level at the first node N1 or the DC link voltage level. For example, the bi-directional converter 113 boosts the battery storage voltage of a DC voltage of 100V stored in the battery 120 to a DC voltage of 380V. However, aspects of the present invention are not limited thereto and other suitable voltage levels may be used. The bi-directional converter 113 of the present embodiment converts the DC power generated by the renewable power generation system 130 or the DC power converted from the AC power supplied from the grid 140 into DC power to be stored in the battery 120, and converts the DC power stored in the battery 120 to DC power to be input into the bi-directional inverter 112 to supply the DC power to the grid 140 or to the load 150.

The battery 120 stores the power supplied from the renewable power generation system 130 or the grid 140. The battery 120 includes a plurality of battery cells, which are connected in series or in parallel with each other, in order to increase a capacity and an output of the battery 120. Additionally, charging and discharging operations of the battery 120 are controlled by the BMS 115 or the integrated controller 114. The battery 120 includes various kinds of batteries, for example, a nickel-cadmium battery, a lead-acid battery, an nickel metal hydride (NiMH) battery, a lithium ion battery, or a lithium polymer battery. However, aspects of the present invention are not limited thereto, and the battery 120 may include other suitable kinds of batteries. A number of battery cells included in the battery 120 is determined according to a power capacity required by the grid-connected energy storage system 100 or conditions of designing the battery 120.

The BMS 115 is connected to the battery 120, and controls charging and/or discharging operations of the battery 120 according to a control of the integrated controller 114. The power discharged from the battery 120 to the bi-directional converter 113 and the power charged in the battery 120 from the bi-directional converter 113 are transferred via the BMS 115. In addition, the BMS 115 has functions such as an over-charging protection, an over-discharging protection, an over-current protection, an overheat protection, and a cell balancing operation. In this regard, the BMS 115 detects a voltage, a current, and a temperature of the battery 120 in order to determine a state of charge (SOC) and a state of health (SOH) of the battery 120, thereby monitoring remaining power and lifespan of the battery 120.

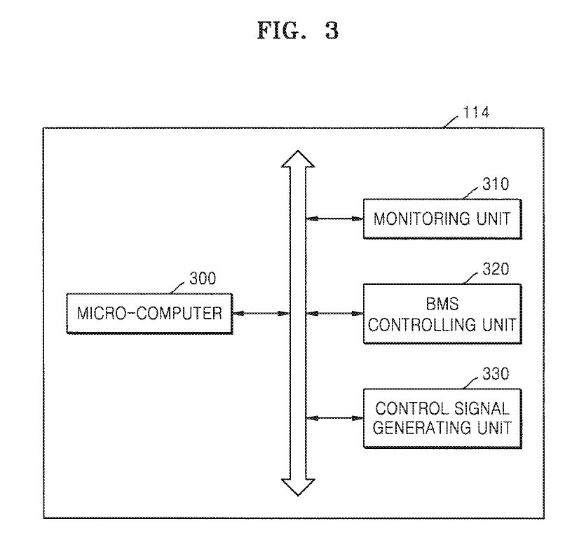

The BMS 115 includes a micro-computer 300 (see FIG. 3) which performs a sensing function detecting the voltage, current, and temperature of the battery 120. Additionally, the micro-computer 300 determines the over-charging, the over-discharging, the over-current, the cell balancing, the SOC, and the SOH, and a protection circuit (not shown) prevents the charging and/or discharging, fusing, and cooling of the battery 120 according to a control signal of the micro-computer. In FIG. 1, the BMS 115 is included in the energy management system 110 and is separated from the battery 120. However, aspects of the present invention are not limited thereto and a battery pack including the BMS 115 and the battery 120 as an integrated body may be formed. In addition, according to the control of the integrated controller 114, the BMS 115 controls the charging and discharging operations of the battery 120, and transfers status information of the battery 120, such as information about a stored charge, i.e., a charged power amount, obtained from the determined SOC, to the integrated controller 114.

The first switch 116 is connected between the bi-directional inverter 112 and a second node N2. The second switch 117 is connected between the second node N2 and the grid 140. The first and second switches 116 and 117 use a switch that is turned on or turned off according to a control of the integrated controller 214. The first and second switches 116 and 117 supply or block the power of the renewable power generation system 130 or the battery 120 to the grid 140 or to the load 150, and supply or block the power from the grid 140 to the load 150 or the battery 120. For example, when the power generated by the renewable power generation system 130 or the power stored in the battery 120 is supplied to the grid 140, the integrated controller 114 turns the first and second switches 116 and 117 on. Also, when the power generated by the renewable power generation system 130 or the power stored in the battery 120 is only supplied to the load 150, the integrated controller 114 turns the first switch 116 on and turns the second switch 117 off. Additionally, when the power of the grid 140 is only supplied to the load 150, the integrated controller 114 turns the first switch 116 off and turns the second switch 217 on.

Abnormal situations occur in the grid 140, such as an electric failure or distribution lines of the grid 140 need to be repaired. When such abnormal situation occur, the second switch 117 blocks the power supply to the grid 140 and makes the grid-connected energy storage system 100 operate solely according to the control of the integrated controller 214. In other words, the second switch 117 disconnects the connection to the grid 140 so that the grid-connected energy storage system 100 operates in a stand-alone operating mode wherein only the power generated by the renewable power generation system 130 or the power stored in the battery 120 is supplied to the load 150. At this time, the integrated controller 114 separates the energy management system 110 from the grid 140 to prevent an accident such as an electric shock to a worker working on or repairing the grid 140 from occurring, and to prevent the grid 140 from badly affecting electrical equipment due to operation in the abnormal status.

In addition, when the grid 140 is returned to a normal status, a phase difference is generated between the voltage of the grid 140 and the output voltage of the battery 120 which is in the stand-alone operating mode, and thus, it is possible to damage the energy management system 110. The integrated controller 114 controls the energy storage system 100 in order to address the problem described above.

The integrated controller 114 controls overall operations of the energy management system 110 or the grid-connected energy storage system 100. According to the present embodiment, the integrated controller 114 senses and receives an electrical failure signal of the grid 140, and performs a control operation on the DC power stored in the battery 120 to be transferred to the load 150. In a general photovoltaic (PV) inverter system, power of the system should be shut down and not used during an electrical failure. That is, since a general PV inverter system operates only in a current mode, an increase of an output voltage may not be blocked during an electrical failure and the stability of the entire system is deteriorated. In other words, in the general PV inverter system using an MPPT converter, the MPPT converter stores a previous value by using a maximum power tracking algorithm and gradually increases or reduces a current capacity, thereby gradually moving to the current value corresponding to the maximum power point. Thus, the MPPT converter may not cope with an instantaneous output voltage increase.

However, in the present embodiment, the MPPT converter 111 and the bi-directional inverter 112 are turned off when an electrical failure occurs and the power stored in the battery 120 is applied to the load 150 by using the bi-directional converter 113. Accordingly, when the integrated controller 114 receives the electrical failure signal from the grid 140, the integrated controller 114 turns the bi-directional converter 113 on and a constant voltage of the first node N1 is controlled. After the voltage of the first node N1 is stably controlled, an uninterruptible power supply (UPS) function of the energy storage system 100 is stably performed when an electrical failure occurs. Also, when the integrated controller 114 receives the electrical failure signal from the grid 140, the integrated controller 114 turns the bi-directional inverter 112 and the MPPT converter 111 off and turns the bi-directional converter 113 on. Then, the integrated controller 114 turns the bi-directional inverter 112 on so as to control the voltage of the first node N1 to be constant and supplies the power stored in the battery 120 to the load 150. Accordingly, an increase of a voltage in an output terminal is prevented so as to prevent the load 150 from being damaged and thus the entire system for protecting the load 150 may be also prevented from being turned off.

Also, the integrated controller 114 first turns the bi-directional converter 113 on so as to control the voltage of the first node N1 to be constant. Also, the integrated controller 114 turns the MPPT converter 111 on again so as to supply the power stored in the battery 120 and the power generated by the renewable power generation system 130 to the load 150. In addition, if a photovoltaic amount is sufficient, the integrated controller 114 turns the bi-directional converter 113 off and the UPS function may be performed only by PV power.

In addition, when the integrated controller 114 receives the electrical failure signal from the grid 140, the integrated controller 114 turns the second switch 117 off and thus disconnects the connection of the energy storage system 100 with the grid 140. Also, after the UPS function by which the power stored in the battery 120 is supplied to the load 150 is performed, the return connection of the grid 140 is identified and then the second switch 117 is turned on. Thus, the grid-connected energy storage system 100 may be normally operated.

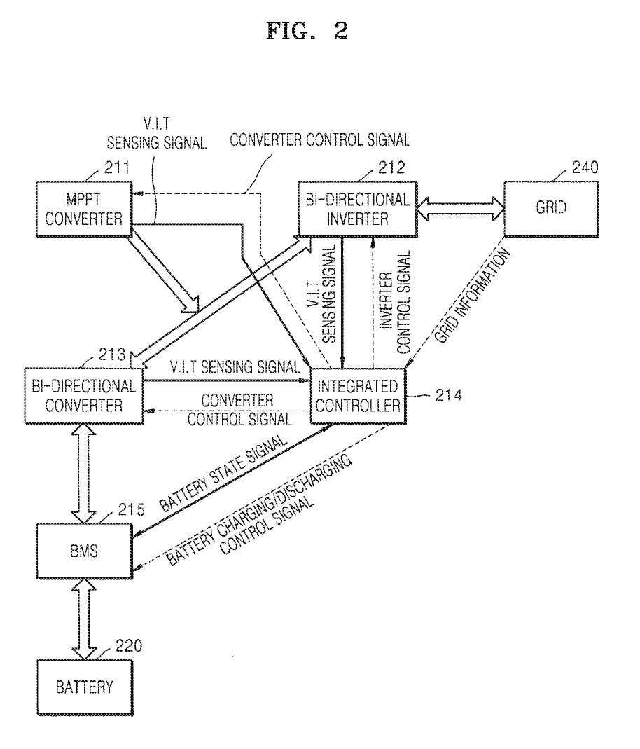

FIG. 2 is a diagram illustrating flows of power and control signals in the grid-connected energy storage system 100 of FIG. 1, according to another embodiment of the present invention. Referring to FIG. 2, the flow of power between the internal components in the grid-connected energy storage system 100 and the flow control signals of an integrated controller 214 are illustrated. As shown in FIG. 2, the DC level voltage, as illustrated by an outlined arrow, converted by an MPPT converter 211 is supplied to a bi-directional inverter 212 and a bi-directional converter 213.

In addition, the DC level voltage supplied to the bi-directional inverter 212 is converted by the bi-directional inverter 212 to the AC voltage, as illustrated by the outlined arrow in FIG. 2, to be supplied to a grid 240, or the DC level voltage supplied to the bi-directional converter 213 is converted by the bi-directional converter 213 to the DC voltage to be stored in a battery 220 and is stored in the battery 220 via a BMS 215. The DC voltage stored in the battery 220 is converted into an input DC voltage level of the bi-directional inverter 212 by the bi-directional converter 213, and then, is converted by the bi-directional inverter 212 into the AC voltage according to standards of the grid 240, to be supplied to the grid 240.

The integrated controller 214 controls overall operations and determines an operating mode of the grid-connected energy storage system 100. For example, the integrated controller 214 determines whether the generated power is supplied to the grid 240, to a load 150 (see FIG. 1), or stored in the battery 220. Additionally, the integrated controller 214 determines whether the power supplied from the grid 240 will be stored in the battery 220.

The integrated controller 214 transmits control signals, as illustrated by dashed arrows in FIG. 2, controlling switching operations of the MPPT converter 211, the bi-directional inverter 212, and the bi-directional converter 213. The control signals reduce a loss of power caused by the power conversion executed by the MPPT converter 211 or the bi-directional inverter 212. The control signals reduce the loss of power by optimally controlling a duty ratio with respect to the input voltage of the each of the MPPT converter 211 and the bi-directional inverter 212. Accordingly, the integrated controller 214 receives signals corresponding to sensing a voltage, a current, and a temperature at an input terminal of each of the MPPT converter 211, the bi-directional inverter 212, and the bi-directional converter 213. Additionally, the integrated controller 214 transmits the converter control signal and the inverter control signal according to the received sensing signals.

The integrated controller 214 receives grid information including information about the grid status and information about a voltage, a current, and a temperature of the grid 240. The integrated controller 214 determines whether an abnormal situation occurs in the grid 240 and whether the power of the grid 240 is returned to a normal operating state. The integrated controller 214 performs a stand-alone operation prevention control through a controlling operation blocking the power supply to the grid 240 and a controlling operation matching the output of the bi-directional inverter 212 and the supplied power of the grid 240 after return to the normal operating state of the power of the grid 240.

The integrated controller 214 receives a battery status signal, which is a signal indicating charging and/or discharging states of the battery 220, through communication with the BMS 215. The integrated controller 214 determines the operating mode of the entire system 100 according to the received signal. In addition, the integrated controller 214 transmits a signal to control charging and/or discharging of the battery 220 to the BMS 215 according to the operating mode. Thus, the BMS 215 controls the charging and discharging operations of the battery 220 according to the transmitted signal.

In the present embodiment, when the integrated controller 214 receives the electrical failure signal from the grid 240, the integrated controller 214 controls the MPPT converter 211 and the bi-directional inverter 212 with the electrical failure signal as a control signal turning off the MMPT converter 211 and the bi-directional inverter 212. Also, the integrated controller 214 turns on the bi-directional converter 213 and discharges the power stored in the battery 220 through the BMS 215. Thereby, the integrated controller 214 stabilizes a voltage increase at the first node N1 due to a power change of the load when an electrical failure occurs by controlling the voltage of the first node N1 to be the DC voltage of the power stored in the battery 220. In addition, the bi-directional inverter 212 is turned on so as to stably supply power to the load. Moreover, when a photovoltaic power amount is sufficient, the MPPT converter 211 may be turned on so as to supply the generated power to the load.

FIG. 3 is a block diagram of the integrated controller 114 illustrated in FIG. 1, according to an embodiment of the present invention. Referring to FIGS. 1 and 3, the integrated controller 114 includes a micro-computer 300, a monitoring unit 310, a BMS controlling unit 320, and a control signal generating unit 330.

The micro-computer 300 controls overall operations of the integrated controller 114. The monitoring unit 310 senses a state of the grid 140 and receives the electrical failure signal of the grid 140. The monitoring unit 310 senses a voltage, a current, and a temperature of the MPPT converter 111, the bi-directional inverter 112, and the bi-directional converter 113. Additionally, the monitoring unit 310 monitors a state of the battery 120, which includes a voltage, a current, a charging and/or a discharging state, and a lifespan of the battery 120 through the BMS 115.

The BMS controlling unit 320 communicates with the BMS 115 and controls the charging and/or discharging operation of the battery 120. In the present embodiment, the BMS controlling unit 320 discharges power stored in the battery 120 when an electrical failure of the grid occurs. The control signal generating unit 330 generates control signals controlling on/off operations of the MPPT converter 111, the bi-directional inverter 112, and the bi-directional converter 113 according to control of the micro-computer 300.

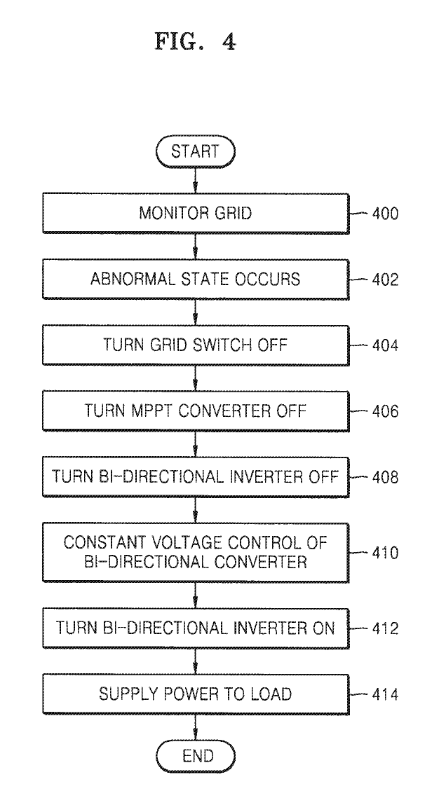

FIG. 4 is a flowchart illustrating a method of controlling an energy storage system, according to an embodiment of the present invention. Referring to FIGS. 1 and 4, a grid 140 is monitored in operation 400. In operation 402, an abnormal status of the grid 140 occurs, wherein the abnormal status includes electrical failure of the grid 140 and power supply being stopped in the grid 140 due to a repair work, or other similar electrical failures of the grid 140. In operation 404, a grid-connected switch, which is a second switch 117, is turned off according to the abnormal status of the grid 140. In operation 406, an MPPT converter 111 is turned off.

In operation 408, a bi-directional inverter 112 is turned off. The MPPT converter 111 and the bi-directional inverter 112 are turned off in order to prevent a voltage increase of an output terminal of the MPPT converter 111 and an input terminal of the bi-directional inverter 112, and damage of a load 150. In operation 410, the bi-directional converter 112 is turned on and a constant voltage control is performed. The bi-directional converter 112 is turned on so as to perform the constant voltage control, which suppresses a voltage increase at the input terminal of the bi-directional inverter 112, by using the power stored in the battery 120. In operations 412 the bi-directional inverter 112 is turned on and in operation 414 the power stored in the battery 120 is stably supplied to the load 150.

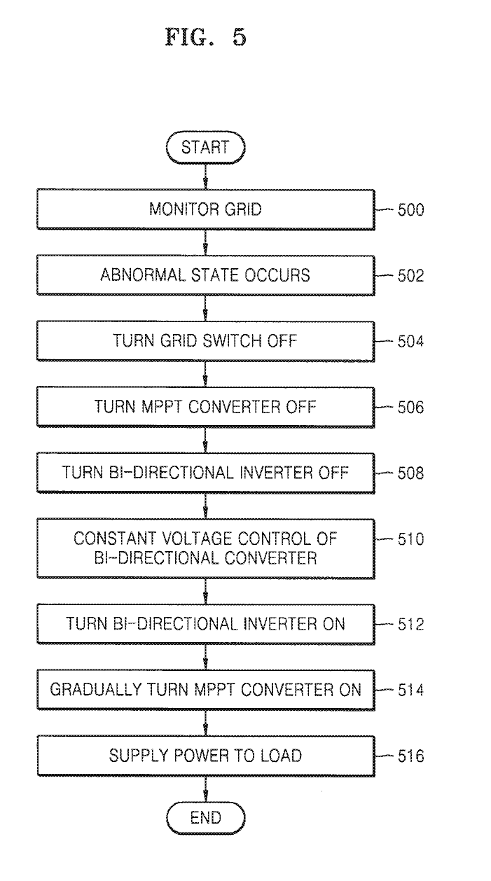

FIG. 5 is a flowchart illustrating a method of controlling an energy storage system, according to another embodiment of the present invention. Referring to FIGS. 1 and 5, a difference between the methods described with reference to FIG. 4 and FIG. 5 is that photo-voltaic (PV) generation is also used in the method described with reference to FIG. 5, thus, only operation 510 will be discussed with reference to FIG. 5. In operation 510, the bi-directional converter 112 is turned on so as to perform the constant voltage control which stabilizes a voltage at an input terminal of the bi-directional inverter 112 by using a power stored in the battery 120 and the MPPT converter 111 is gradually turned on so as to perform a UPS function in which PV generation is used.

In addition, when the UPS function is performed sufficiently using only the PV generation, the bi-directional converter 112 is turned off so as to block the power stored in the battery 120 from being supplied to the load 150 and only PV generation may be supplied to the load 150.

As described above, according to the one or more of the above embodiments of the present invention, in the energy storage system 100, a normal operation of the system and the UPS function due to electrical failure of the grid 140 may be stably performed even if electrical failure of the grid 140 occurs.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An energy storage system comprising:
a maximum power point tracking (MPPT) converter converting power generated by a renewable power generation system and outputting the converted power to a first node;
a bi-directional inverter, connected between the first node and a second node, the second node being connected to a grid and a load, converting a first direct current (DC) power input through the first node to an alternating current (AC) power and outputting the AC power to the second node, and converting an AC power from the grid to the first DC power and outputting the first DC power to the first node;
a battery for storing a second DC power;
a bi-directional converter, connected between the battery and the first node, converting the second DC power output from the battery to the first DC power and outputting the first DC power to the bi-directional inverter through the first node, and converting the first DC power output from the bi-directional inverter through the first node to the second DC power; and
an integrated controller sensing an electrical failure signal of the grid and controlling the second DC power stored in the battery to be transferred to the load when the electrical failure signal is received.

2. The system of claim 1, wherein the integrated controller turns the bi-directional converter on and performs constant voltage control of the first node when the electrical failure signal is received.

3. The system of claim 1, wherein when the electrical failure signal is received, the integrated controller turns the bi-directional inverter and the MPPT converter off, turns the bi-directional converter on, and turns the bi-directional inverter on.

4. The system of claim 1, further comprising:
a first switch connected between the bi-directional inverter and the load; and
a second switch connected between the second node and the grid.

5. The system of claim 4, wherein when the electrical failure signal is received, the integrated controller turns the second switch off.

6. The system of claim 3, wherein the integrated controller turns the bi-directional inverter on and turns the MPPT converter on.

7. The system of claim 6, wherein the integrated controller turns the MPPT converter on and then turns the bi-directional converter off.

8. The system of claim 1, further comprising a battery management system (BMS) managing charging and/or discharging the second DC power stored in the battery according to control of the integrated controller.

9. The system of claim 1, further comprising a DC link unit maintaining a DC voltage level of the first node to a DC link level.

10. The system of claim 1, wherein the renewable power generation system is a Photovoltaic (PV) system.

11. A method of controlling an energy storage system supplying power to a load when an electrical failure occurs in a grid, wherein the energy storage system is connected to a renewable power generation system, the load, and the grid and the energy storage system includes: a maximum power point tracking (MPPT) converter outputting converted power to a first node; a battery storing power; a bi-directional inverter converting power and outputting the converted power to the load, the grid or the first node; a bi-directional converter converting and storing power in the battery and outputting the power stored in the battery to the first node; and an integrated controller, the method comprising:
receiving an electrical failure signal of the grid;
turning the MPPT converter and the bi-directional inverter off;
turning the bi-directional converter on;
performing constant voltage control of the first node to stabilize the first node;
turning the bi-directional inverter on; and
supplying the power stored in the battery to the load.

12. The method of claim 11, wherein the bi-directional converter converts a first direct current (DC) voltage of the power stored in the battery into a second DC voltage and performs the constant voltage control of the first node.

13. The method of claim 11 further comprising, when the voltage of the first node is stabilized, turning the MPPT converter on and supplying power generated by the renewable power generation system to the load.

14. The method of claim 13, further comprising turning the bi-directional converter off and stopping the supplying of the power stored in the battery.

15. The method of claim 11, when the electrical failure signal is received, further comprising turning off a switch connected to the grid.

16. The method of claim 11, wherein the renewable power generation system is a Photovoltaic (PV) system.

17. The method of claim 11, further comprising stabilizing a voltage level of the first node to be at a voltage level of a direct current (DC) link.

18. The method of claim 11, further comprising controlling discharging of the battery so that the power stored in the battery is input to the bi-directional converter.
